(19) United States
(12) Patent Application Publication
(10) Pub. No.: US 2013/0202928 A1
(43) Pub. Date: Aug. 8, 2013

(54) BUSBAR INCLUDING FLEXIBLE CIRCUIT

(71) Applicants: Marc Beulque, Waregem (BE); Stefan Desmet, Wetteren (BE)

(72) Inventors: Marc Beulque, Waregem (BE); Stefan Desmet, Wetteren (BE)

(73) Assignee: Rogers Corporation, Rogers, CT (US)

(21) Appl. No.: 13/569,651

(22) Filed: Aug. 8, 2012

Related U.S. Application Data
(60) Provisional application No. 61/521,169, filed on Aug. 8, 2011.
(60) Provisional application No. 61/521,163, filed on Aug. 8, 2011.

(51) Int. Cl. H01M 2/20

(52) U.S. Cl. CPC H01M 2/206
USPC 429/90; 439/754

(57) ABSTRACT

A multilayer busbar for connecting a plurality of battery cells includes a cell connection layer including a plurality of conductor plates arranged to serially connect the plurality of battery cells. The busbar also includes a flexible circuit layer including a substrate having a plurality of measurement lines formed on it where the measurement lines are arranged to connect to a positive and a negative connection location on at least two of the plurality of battery cells.

### CROSS-REFERENCE TO RELATED APPLICATIONS AND PRIORITY CLAIM

This application is a Nonprovisional of U.S. patent application Ser. No. 61/521,169, filed Aug. 8, 2011, under 35 U.S.C. § 119(e), which is incorporated herein by reference in its entirety.

### BACKGROUND OF THE INVENTION

The subject matter disclosed herein relates to battery systems and, more particularly, to battery systems where the state of charge of each battery cells in a connected group of batteries is monitored, and more particularly to battery systems in electric or hybrid electric vehicles.

Hybrid electric vehicles (HEVs) are vehicles that include both an internal combustion engine (ICE) and an electric motor. Such vehicles can, in some instances, provide greater fuel economy than a vehicle that includes only an ICE. Full electrical vehicles have only one or multiple electrical motors.

In either type of device, the electric motor receives power from a battery unit. The battery unit typically includes two or more serially connected battery cells. In the case of a full electric vehicle, the number of battery cells can be in the hundreds. During operation it is advantageous if each cell can be monitored individually. For instance, monitoring each cell during charging operations can increase safety. In addition, knowledge of the charge in the cells can be used to predict vehicle range or lifetime of the cells themselves.

Traditionally, the cells are serially connected to one another to form the battery unit. Then, sensor wires are connected to the terminals of each cell. The sensor wires are then bundled together by a harness that is mounted on top of the cells. This approach, while effective, can be slow and prone to connection errors.

### BRIEF DESCRIPTION OF THE INVENTION

According to one embodiment of the present invention, a multilayer busbar for connecting a plurality of battery cells is disclosed. The busbar of this embodiment includes a cell connection layer including a plurality of conductor plates arranged to serially connect the plurality of battery cells and a flexible circuit layer including a substrate having a plurality of measurement lines formed on it. The measurement lines are arranged to connect to a positive and a negative connection location on at least two of the plurality of battery cells.

According to another embodiment of the present invention, a battery system for a vehicle is disclosed. The battery system includes a plurality of battery cells and a multilayer busbar for connecting the plurality of battery cells. The busbar includes a cell connection layer including a plurality of conductor plates arranged to serially connect the plurality of battery cells and a flexible circuit layer including a substrate having a plurality of measurement lines formed on it. The measurement lines are arranged to connect to a positive and a negative connection location on at least two of the plurality of battery cells. The busbar also includes an insulating layer disposed between the conductor plates and the flexible circuit layer.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a top view of a battery compartment that includes a plurality of serially connected battery cells;

FIG. 2 is a line diagram illustrating a flexible circuit according to one embodiment; and

FIG. 3 illustrates an exploded view of a multilayer busbar according to one embodiment of the present invention.

The detailed description explains embodiments of the invention, together with advantages and features, by way of example with reference to the drawings.

### DETAILED DESCRIPTION OF THE INVENTION

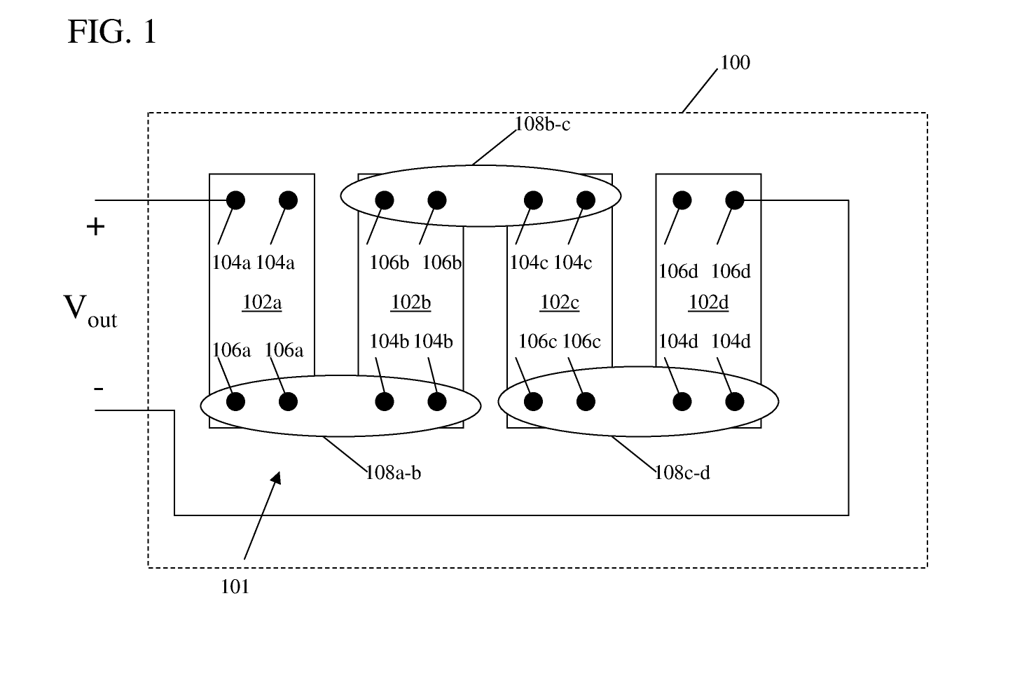

Referring to FIG. 1, a battery enclosure 100 is illustrated that contains a battery system 101. The battery enclosure 100 and battery system 101 can be located, for example, in a hybrid electric vehicle (HEV) or a full electric vehicle. In other instances, the battery enclosure 100 and/or the battery system 101 could be in any type of device that includes batteries such as, for example, a wind turbine. The battery system 101 includes a plurality of serially connected battery cells (cells) 102a-102d. The cells will collectively be referred to as cells 102 from time to time herein. As illustrated, the battery system 101 includes four cells 102a-102d. Of course, the number of cells 102 in the system 101 can be any number greater than one. As illustrated, all the cells 102 are included in a single battery enclosure 100. In some instances, additional cells 102 could be located in different enclosures (not shown).

Regardless of the configuration, the battery system 101 can provide an output voltage Vₒᵤₜ. In some cases, Vₒᵤₜ can be provided to an electric motor in an HEV. Each illustrated cell 102a-102d includes a pair of positive terminals 104 and a pair of negative terminals 106. In particular, cell 102a includes a pair of positive terminals 104a and a pair of negative terminals 106a, cell 102b includes a pair of positive terminals 104b and a pair of negative terminals 106b, cell 102c includes a pair of positive terminals 104c and a pair of negative terminals 106c, and cell 102d includes a pair of positive terminals 104d and a pair of negative terminals 106d. It shall be understood that each cell 102 need not a pair of either positive or negative terminals. That is, each cell could include any number of terminals as long as it provides at least one positive connection point and one negative connection point. As illustrated, the paired positive 104 and negative terminals 106 on each cell 102 are provided as redundant failsafe connections.

Those of skill in the art generally know how to serially connect cells 102. As such, the particular configuration of cells 102 is not meant to be limiting and is merely one configuration of many that could be employed. The particular arrangement shown in FIG. 1 has each cell 102 arranged in an opposite orientation than at least one neighboring cell 102. In particular, the negative terminals 106a are arranged adjacent to the positive terminals 104b and the negative terminals 106b are arranged adjacent positive terminals 104c and so on.

According to one embodiment, the terminals 104, 106 of one cell are connected to the terminals 104, 106 of an adjacent cell by one or more conductor plates 108. As illustrated, the negative terminals 106a of cell 102a are connected to the positive terminals 104b of cell 102b by conductor plate 108a-b, the negative terminals 106b of cell 102b are connected to the positive terminals 104c of cell 102c by conductor plate 108b-c, and the negative terminals 106c of cell 102c are connected to the positive terminals 104d of cell 102d by conductor plate 108c-d. As one of skill will appreciate, such a connection scheme provides for the serial connection of cells 102a-102d and provides for output voltage Vₒᵤₜ between the positive terminals 104a of cells 102a and negative terminals 106d of cell 106d. While designated as Vₒᵤₜ it shall be understood the cells 102 can be charged by application of a voltage/current across the positive terminals 104a of cells 102a and negative terminals 106d of cell 106d.

It shall be understood that the output voltage Vₒᵤₜ can be presented as separate connection or can be included in a pin-connector or other type of connector element. In addition, the output voltage Vₒᵤₜ could be included in a connector element that includes other electrical connections.

The conductor plates 108 can be made of different types of conductive metals, for example stainless steel, copper, aluminum, zinc, iron, transition metals, and alloys including at least one of the foregoing. In one embodiment, the conductor plates 108 are formed of metal that is plated with tinplating or nickelplating. The thickness of the conductor plates 108 can have any thickness, shape, size or texture depending on the context. The conductor plates 108 can have any number of holes formed therein depending on the number and location of terminals 104, 106 on the cells 102. In one embodiment, the holes may include dishing and/or bushings disposed therein to level contact points between the conductor plates 108. As will be explained in further detail below, in one embodiment, some or all of the conductor plates 108 can be included in one of, or enclosed between, the layers of a multilayer busbar.

As described above, in addition to providing power, it may be desired to measure one or more parameters of the individual cells. As such, in the prior art, wires were coupled to the terminals 104, 106 to allow for the charge in each cell 102 to be measured. These wires were then bundled together and, as such, took up space in the battery compartment.

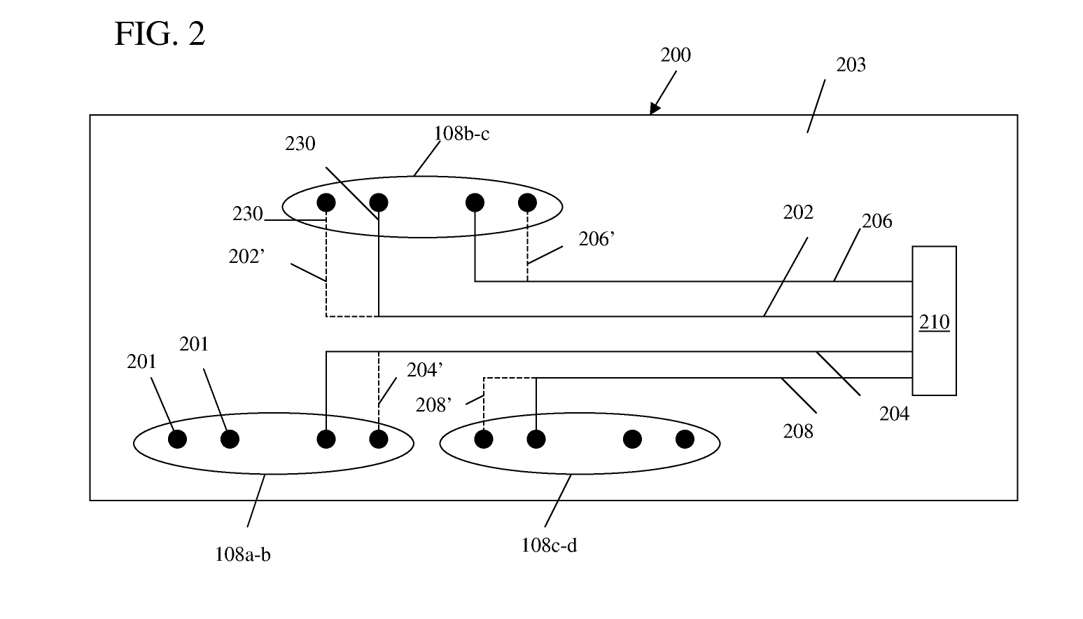

FIG. 2 illustrates measurement lines 202, 204, 206 and 208 that could be connected to different terminals of one or more cells 102. For clarity, the cells 102 are not shown in FIG. 2 but it shall be understood that the cells could be configured as shown in FIG. 1, for example. In FIG. 2, each of the conductor plates 108a-b, 108b-c and 108c-d include holes 201 sized to allow cell terminals to pass through them. According to one embodiment, a flexible circuit 200 is provided that can be displaced either above or below the conductor plates 108 relative to the cells. The flexible circuit 200 includes measurement lines 202, 204, 206 and 208 formed thereon. The flexible circuit 200 can include a substrate layer 203. The measurement lines 202-208 can be formed on one or both sides of the substrate layer 203. The substrate layer 203 can be formed, for example, of polyesters such as certain liquid crystal polymers (LCP), polyethylene terephthalate (PET), polyethylene naphthalate (PEN), and the like; fluorinated polymers and copolymers such as polytetrafluoroethylene (PTFE), polyimide (PI), polyetherimide (PEI), and epoxy. On any of these substrate materials 203, the required number of measurement lines can be formed and arranged such they include connection ends 230 that overlie where the holes 201 will exist when placed on top of battery cells. The other end of the measurement lines can be coupled to a connector 210 in one embodiment. The connector 210 can be formed in or coupled to the substrate 203 in one embodiment. Of course, the connector 210 could be omitted or could be provided as a separate element depending on the context.

The measurement lines 202-208 provide a connection mechanism for a device (not shown) to monitor the charge or other parameter of the cells to which the lines are connected. In particular, assuming that the flexible circuit 200 is overlaid over cells arranged as in FIG. 1, the voltage in cell 102b can be measured between measurement lines 202 and 204 and the voltage in cell 102c can be measured between measurement lines 206 and 208. It shall be further understood that the flexible circuit can include other measurement lines that are configured to connect to other portions of a cell such as, for example, a sensor or other output. In addition, and as shown in FIG. 2, to the extent that the cells include redundant terminals, one or more of the measurement lines 202-208 can include a redundant path 202′-208′ that couples to the redundant terminal

In contrast to the prior art, because the measurement lines 202-208 are formed on a substrate, all of the lines are contained in a thin layer, do not need separate bundling, and operator connection error can be reduced or eliminated. With a knowledge of how the cells in a battery compartment are to be arranged, the particular configuration of the measurement lines 202-208 can be determined. As such, it shall be understood that the measurement lines can be laid out in any configuration and the configuration shown in FIG. 2 is merely by way of example.

It shall be understood that in one embodiment, the flexible circuit 200 is physically separated from the conductor plates such that none of the measurement lines 202-208 physically contact the conductor plates 108. The measurement lines 202-208 can have any thickness but generally may be 12, 18, 35 or 70 micrometers thick and can be formed of a conductive metal such as copper. In one embodiment, the copper is plated with tin, gold, or combinations or allows thereof such as Ni—Au. While not illustrated, it will be understood that the flexible circuit 200 can include a layer of cover coat or other insulator disposed on some or all of one or both of the sides of it.

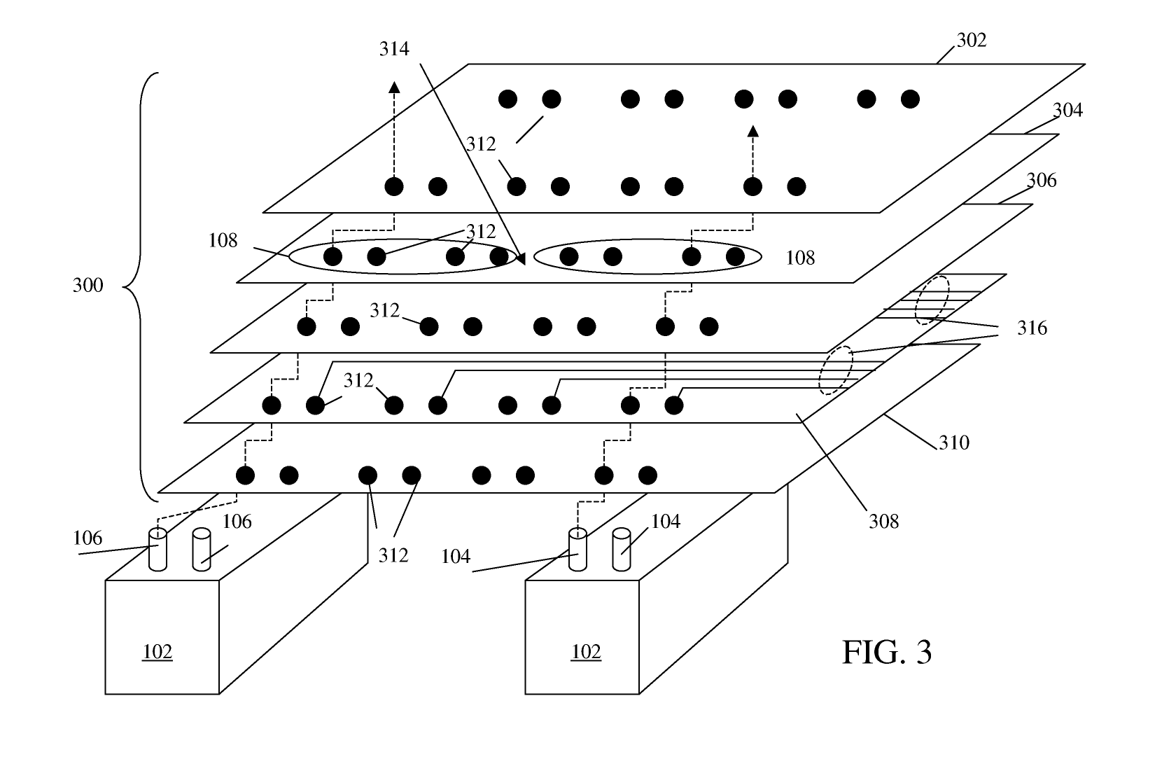

FIG. 3 illustrates an exploded view of a multilayer busbar 300 according to one embodiment. The multilayer busbar 300 is arranged and configured such that it includes a plurality of access holes 312 placed such that can allow terminals 104, 106 of cells 102 to pass through them. Such passage allows electrical elements in the multilayer busbar 300 to form electrical contact with the terminals 104, 106. Such contact can provide for serially coupling the cells 102 and for monitoring the voltage on each cell 102, for example. In one embodiment, all of the layers 302-308 of the multilayer busbar 300 are sandwiched together and form a flexible unit. It will be understood, however, that the cells 102 may not include terminals 104, 106 as illustrated in FIG. 3. In such a case, other means, such as compressive polymer, can be included in the multilayer busbar to urge the electrical elements (e.g., wires 316 and/or connection plates 108) into electrical communication with the electrical connection locations on the cells 102.

The illustrated multilayer busbar 300 includes outer layers 302 and 310 which serve to seal and encase the other layers. The outer layers 302 and 310 can be formed of adhesive coated insulation based on polyethylene tereftalate (PET), polyimide (PI) or polyethylene naphtalate (PEN) films It shall be understood, however, that one or both of the outer layers 302, 310 could be omitted.

A cell connection layer 304 is adjacent outer layer 302 and includes one or more conductor plates 108. While the connection layer 304 is illustrated as a physical element that carries conductor plates 108, it shall be understood the connection layer 304 could only include the conductor plates 108. It shall further be understood that one or both of the outer layers 302, 310 could include cavities or cut outs arranged to receive the conductor plates 108. The conductor plates 108 can be arranged such that a flex region 314 exists between them to allow the multilayer busbar 300 to flex.

A flexible circuit layer 308 includes a flexible circuit that includes measurement lines 316 formed therein. The flexible circuit layer 308 could be formed, for example, as described above with respect to the flexible circuit 200 of FIG. 2. The relative order of the layers 304-308 can vary from that shown in FIG. 3. For example, the cell connection layer 304 could be below the flexible circuit layer 308. Regardless of the configuration, an insulating layer 306 is disposed between the cell connection layer 304 and the flexible circuit layer 308 so that the conductor plates 108 do not short any of the measurement lines 316 to one another.

In one embodiment, the cell connection layer 304 and the flexible circuit layer 308 are not bonded to each other. Rather, these layers could each be laid over the batteries and held together, for example, by fasteners that couple them to terminals on the batteries.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A multilayer busbar for connecting a plurality of battery cells, the busbar comprising:
a cell connection layer including a plurality of conductor plates arranged to serially connect the plurality of battery cells; and
a flexible circuit layer including a substrate having a plurality of measurement lines formed on it, the measurement lines being arranged to connect to a positive and a negative connection location on at least two of the plurality of battery cells; and

2. The multilayer busbar of claim 1, further comprising:
a plurality of outer layers that encase at least a portion of the cell connection layer, the flexible circuit layer and the insulating layer.

3. The multilayer busbar of claim 1, further comprising:
a connector that provides a connection for an external device to connect to the measurement lines.

4. The multilayer busbar of claim 3, wherein the connector is coupled to the substrate.

5. The multilayer busbar of claim 3, wherein the connector is electrically connected to the plurality of conductor plates.

6. The multilayer busbar of claim 1, wherein the cell connection layer, the flexible circuit layer and the insulating layer include holes arranged to allow terminals on the cells to pass through them.

7. The multilayer busbar of claim 1, wherein the conductor plates are arranged such that the multilayer busbar can flex.

8. The multilayer busbar of claim 1, wherein the conductor plates include holes formed therein to allow terminals on the cells to pass there through.

9. The multilayer busbar of claim 1, wherein the conductor plates comprise copper, aluminum or a combination of copper and aluminum

10. The multilayer busbar of claim 1, wherein the conductor plates includes a coating comprising copper, aluminum, or combination of copper and aluminum.

11. The multilayer busbar of claim 1, wherein the measurement lines comprise copper.

12. The multilayer busbar of claim 11, wherein the measurement lines comprises a plating comprising tin, silver, nickel, gold or a combination of nickel and gold.

13. The multilayer busbar of claim 1, in combination with the plurality of battery cells.

14. The multilayer busbar of claim 1, further comprising:
an insulating layer disposed between the conductor plates and the flexible circuit layer.

15. A battery system for a vehicle, the system comprising:
a plurality of battery cells; and
a multilayer busbar for connecting the plurality of battery cells, the busbar including:
a cell connection layer including a plurality of conductor plates arranged to serially connect the plurality of battery cells;
a flexible circuit layer including a substrate having a plurality of measurement lines formed on it, the measurement lines being arranged to connect to a positive and a negative connection location on at least two of the plurality of battery cells; and
an insulating layer disposed between the conductor plates and the flexible circuit layer.

16. The battery system of claim 15, further comprising:
a battery compartment containing the battery cells.

17. The battery system of claim 16, wherein the battery compartment is located in the vehicle.

18. The battery system of claim 15, wherein the multilayer busbar further includes:
a plurality of outer layers that encase at least a portion of the cell connection layer, the flexible circuit layer and the insulating layer.

19. The battery system of claim 15, wherein the multilayer busbar further includes:
a connector that provides a connection for an external device to connect to the measurement lines.
